(19) United States
(12) Patent Application Publication
(10) Pub. No.: US 2019/0105134 A1
(43) Pub. Date: Apr. 11, 2019

(54) DENTURE FABRICATION

(71) Applicant: Henry Schein, Inc., Melville, NY (US)

(72) Inventors: Robert Neil Cohen, Gloucester, MA (US); Ryan Faufau, Golden, CO (US)

(21) Appl. No.: 16/153,275

(22) Filed: Oct. 5, 2018

Related U.S. Application Data
(60) Provisional application No. 62/569,512, filed on Oct. 7, 2017.

(51) Int. Cl. A61C 13/07; A61C 13/00; A61C 13/10; A61C 13/34; A61C 13/01

(52) U.S. Cl. CPC A61C 13/0025; A61C 13/0004; A61C 13/0019; A61C 13/01; A61C 13/102; A61C 13/34; A61C 13/0024

(57) ABSTRACT

A single denture model that includes both tooth and soft tissue portions (e.g., gums and palate) may be provided in a computer-aided design (CAD) or computer-aided manufacturing (CAM) modeling environment. By cutting back soft tissue surfaces of the virtual denture model within the modeling environment, cutback volumes are formed that provide space for the subsequent application of a soft tissue insert that mimics soft tissue. A denture base including these cutback volumes can be fabricated from the virtual denture model, e.g., by milling or three-dimensional printing, and soft tissue inserts (e.g., custom-fabricated or prefabricated inserts) can be assembled onto the denture base to form a complete denture.

### RELATED APPLICATIONS

This application claims the benefit of U.S. Prov. App. No. 62/569,512 filed on Oct. 7, 2017, the entire contents of which are hereby incorporated by reference.

### TECHNICAL FIELD

The present disclosure generally relates to denture fabrication, and more specifically to using computer-aided design (CAD) and computer-aided manufacturing (CAM) techniques to provide one or more denture parts for assembly of a denture.

### BACKGROUND

Dentures generally include two distinct components—(1) a denture base that fits the edentulous ridge and mimics the appearance of soft tissue (e.g., by having a pink color), and (2) denture teeth that are bonded to the denture base and are substantially tooth-colored. Often, denture fabrication is done by hand, e.g., by a dental technician, through what is generally an eight to ten step lab process, including the technician and a dentist working together to create a satisfactory final prosthesis. There remains a need for improved denture fabrication techniques.

### SUMMARY

A single denture model that includes both tooth and soft tissue portions (e.g., gums and palate) may be provided in a computer-aided design (CAD) or computer-aided manufacturing (CAM) modeling environment. By cutting back soft tissue surfaces of the virtual denture model within the modeling environment, cutback volumes are formed that provide space for the subsequent application of a soft tissue insert that mimics soft tissue. A denture base including these cutback volumes can be fabricated from the virtual denture model, e.g., by milling or three-dimensional printing, and soft tissue inserts (e.g., custom-fabricated or prefabricated inserts) can be assembled onto the denture base to form a complete denture.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 shows a denture.

FIG. 2 shows a digital denture model.

FIG. 3 shows a digital denture model with markings for placement of cutbacks.

FIG. 4 shows a digital denture model with cutbacks being removed.

FIG. 5 shows a denture base.

FIG. 6 shows a denture base and soft tissue inserts aligned for engagement.

FIG. 7 shows a denture.

FIG. 8 shows digital denture models.

FIG. 9 shows a denture.

FIG. 10 shows soft tissue inserts.

FIG. 11 is a flow chart of a method for making a denture.

FIG. 12 is a flow chart of a method for making a denture.

FIG. 13 is a flow chart of workflows for making a denture.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are incorporated by reference in their entirety. References to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

Described herein are devices, systems, and methods for denture fabrication. Although the disclosure may emphasize techniques for designing and fabricating dentures, other dental appliances (or other appliances in general) known in the art may also or instead be designed and fabricated using the same or similar techniques as disclosed herein. All such appliances and fabrication techniques that can benefit from the disclosed techniques are intended to fall within the scope of this disclosure, and within the scope of the term “denture” unless explicitly stated to the contrary or otherwise clear from the text.

In general, dentures may include two distinct components, a base that fits the edentulous ridge and mimics the appearance of soft tissue, e.g., by being colored pink and textured accordingly, and denture teeth that are bonded to the denture base and are generally tooth-colored. As stated above, existing denture fabrication processes may include a number of tedious steps, many of which are performed by hand and/or require substantial skill. By way of example, a typical denture fabrication process of the prior art begins with taking an impression of a patient's mouth to create molds/models thereof. Premade teeth may then be positioned within the model of the patient's mouth, where wax or the like is used to hold the teeth in place. The wax may be manipulated and sculpted to look like the patient's natural gums on the denture model. Then, the wax from the denture model may be turned into a plastic/acrylic material or the like to create the final denture by “investing” the denture. In an investing process, an injection flask is used to encase the denture model in plaster or the like. After the plaster hardens, the wax can be removed through heating, and the wax may be replaced with an acrylic material by injection into the plaster mold. After more steps for curing and hardening the acrylic, the denture may be trimmed and polished to create the final denture.

More recently, through the development of computer-aided design (CAD) and computer-aided manufacturing (CAM) software, there have been opportunities to automate some, or all, of the production process for creating a denture. Although not mainstream, there are some viable automated manufacturing protocols that include CAD for designing the denture and the use of three-dimensional printing or milling technology to fabricate dentures or denture parts. For example, automated denture fabrication may include printing or milling the denture base from a CAD file (e.g., a stereolithography (STL) file), and bonding prefabricated denture teeth into the denture base. Automated denture fabrication may also or instead include milling or printing the denture teeth, which can then be bonded onto a milled or printed denture base, where one or more of the denture teeth and the denture base are created from a CAD file. Automated denture fabrication may also or instead include the use of a pink denture milling disc that comes with some or all of the denture teeth preboned into the disc. The final denture is then fabricated by milling this structure into a final form.

The disclosed techniques can improve upon these existing techniques and simplify denture fabrication by combining soft tissue inserts with a single, fabricated denture base, all formed from a single digital dental model. A digital denture model may be designed within a CAD or CAM modeling environment to include one or more cutbacks within soft tissue portions thereof, thus providing space for the application of soft tissue inserts that mimic the soft tissue of a patient's gingiva, palate, and the like. Also, or instead, cutbacks can be formed in support areas of the digital denture model to provide space for support inserts. In this manner, in certain implementations, the denture fabrication process can be simplified, e.g., from an eight to ten step process to a two to three step process. An example of an improved process may include (1) providing a digital denture model and adding the cutbacks, (2) fabricating the denture base and a soft tissue insert, and (3) assembling the soft tissue insert to the fabricated denture base to form a complete, final denture.

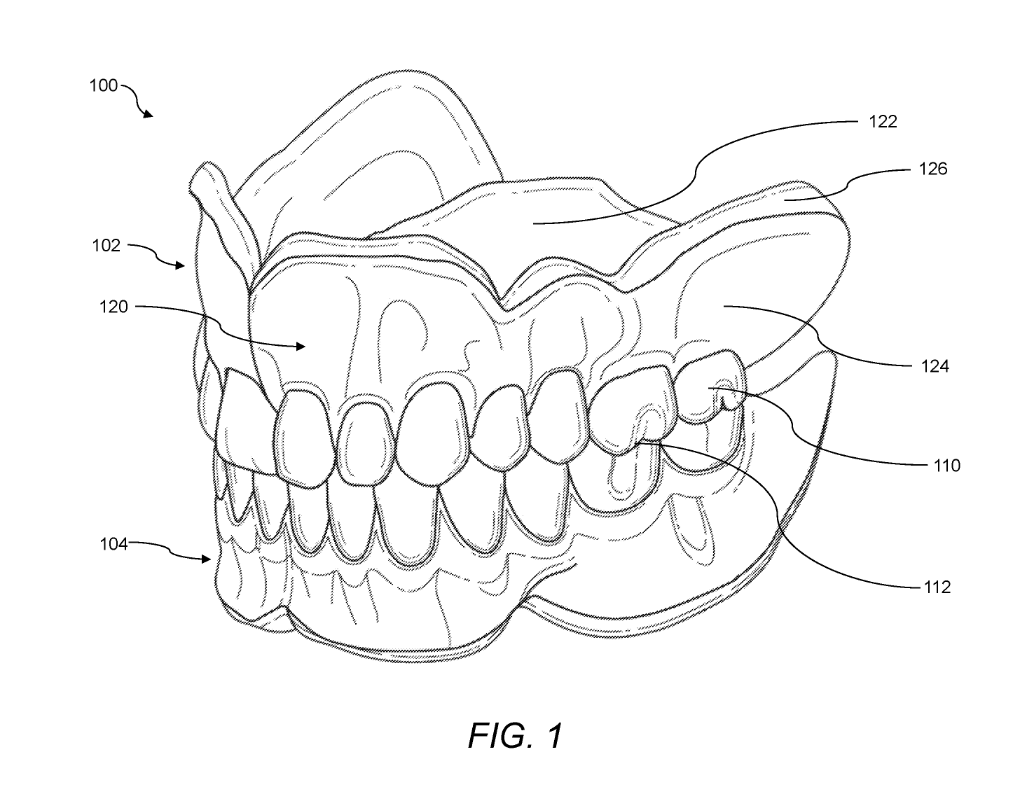

FIG. 1 shows a denture. In general, a denture 100 as described herein may include reconstructed patient dentition that forms a removable appliance for a patient, e.g., when placed for use on the existing patient dentition. Because a denture 100 mimics the appearance and anatomy of patient's dentition, it will be understood that the portions and components of the denture 100 may also include intraoral structures of a patient, or the portions/components of the denture 100 may correspond to, engage, or otherwise cooperate with, such intraoral structures. The denture 100 may be embodied, e.g., in a digital model, a multi-part digital model (e.g., with separate models for a base, teeth, soft tissue, and so on), a physical model such as a plaster model or other cast, or any other electronic or physical form.

As shown in the figure, the denture 100 may include an upper jaw portion 102 and a lower jaw portion 104, although some dentures 100 may only include one such portion (or less, e.g., a fraction or portion of one or more of the upper jaw and the lower jaw). The denture 100 may further include one or more teeth 110 and one or more soft tissue surfaces 120.

The teeth 110 may include one or more tooth surfaces corresponding to exposed tooth regions in the reconstructed patient dentition, such as one or more occlusal surfaces 112 where opposing teeth contact, buccal surfaces, lingual surfaces, and so forth.

The soft tissue surfaces 120 may correspond to, or be configured for engagement with, intraoral anatomy such as a patient's gums or other soft tissue regions. By way of example, the soft tissue surfaces 120 may include a top engagement region 122 structurally configured to match and engage with the top palate and other existing intraoral structures of a patient. In this manner, the top engagement region 122 may include a replica of the palate on an opposite side thereof. The soft tissue surfaces 120 may also or instead include a buccal flange 124 structurally configured for engagement with the buccal vestibule of a patient's mouth, and a border region 126.

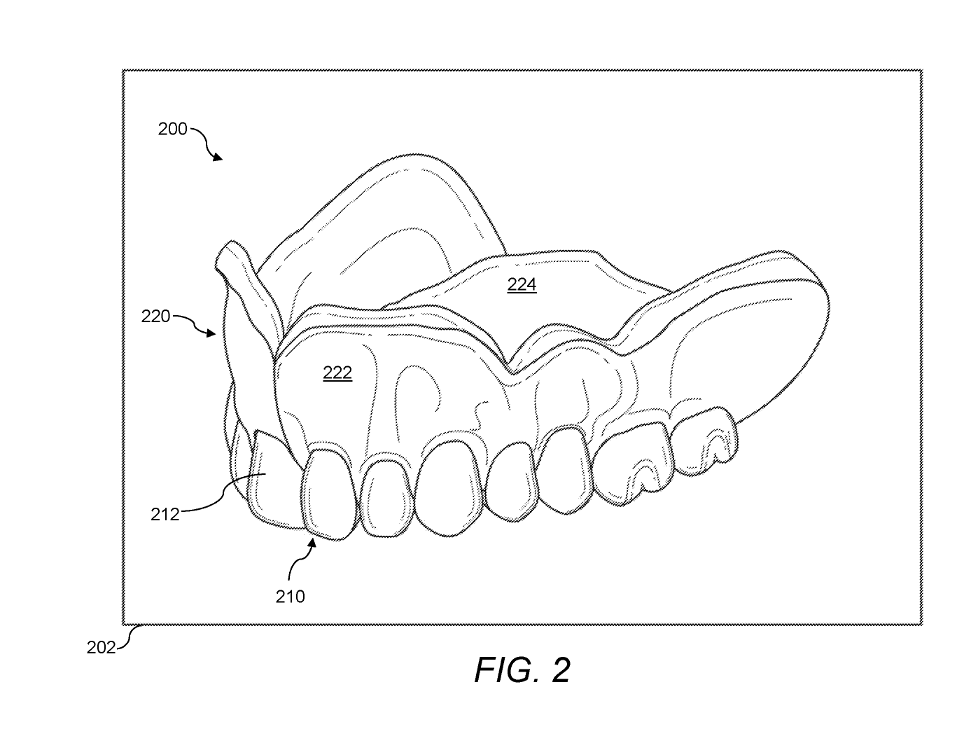

FIG. 2 shows a digital denture model. Although the digital denture model 200 includes only a top jaw portion, it will be understood that a bottom jaw portion may also or instead be provided. Similarly, only a portion of one or more of the top jaw and/or bottom jaw may be provided for the digital model. The digital denture model 200 may be provided in a digital modeling environment 202, where the digital denture model 200 is shaped to provide reconstructed patient dentition for existing patient dentition when placed for use on the existing patient dentition. It will be appreciated that, while the digital denture model 200 depicted in FIG. 2 is a model for a full denture, the digital denture model 200 may also or instead include a partial denture for any suitable subset of teeth to complement existing patient dentition, and references to a denture model or digital denture model herein should be understood to contemplate full and partial denture models unless explicitly stated to the contrary or otherwise clear from the context.

As shown in the figure, the digital denture model 200 may include an integral digital representation of a denture structure that contains one or more tooth surfaces 212 corresponding to exposed tooth regions 210 in the reconstructed patient dentition. The digital denture model 200 may further include one or more soft tissue surfaces 222 corresponding to soft tissue 220 in the reconstructed patient dentition. The digital denture model 200 may also include one or more support surfaces 224 corresponding to regions where the denture structure mechanically matches and engages with one or more exposed intraoral structures in existing patient dentition, such as a patient's top palate.

The digital denture model 200 may include both the teeth and the denture base, which may be integrated into a single model or provided as independent three-dimensional digital models at any suitable level of granularity (e.g., for individual teeth, groups of teeth, an entire jaw with teeth, and so on). A denture corresponding to the digital denture model 200 can be milled (e.g., with a CNC machine or the like) or three-dimensionally printed, e.g., using a tooth-colored material, from a single STL file. As described in more detail below, in implementations described herein, before fabricating a denture from the digital denture model 200, portions of the digital denture model 200 may be reduced to accept the application of one or more inserts, e.g., pink, tissue-like inserts for the flanges and palate areas of a one-piece denture. In general, the physical denture may be fabricated from a material that is functionally suitable for replacing existing dentition such as a ceramic or the like. In another aspect, a positive or negative impression of the physical denture may be fabricated from another material such as a plastic, and then used in a casting process or the like to fabricate the final, physical denture base.

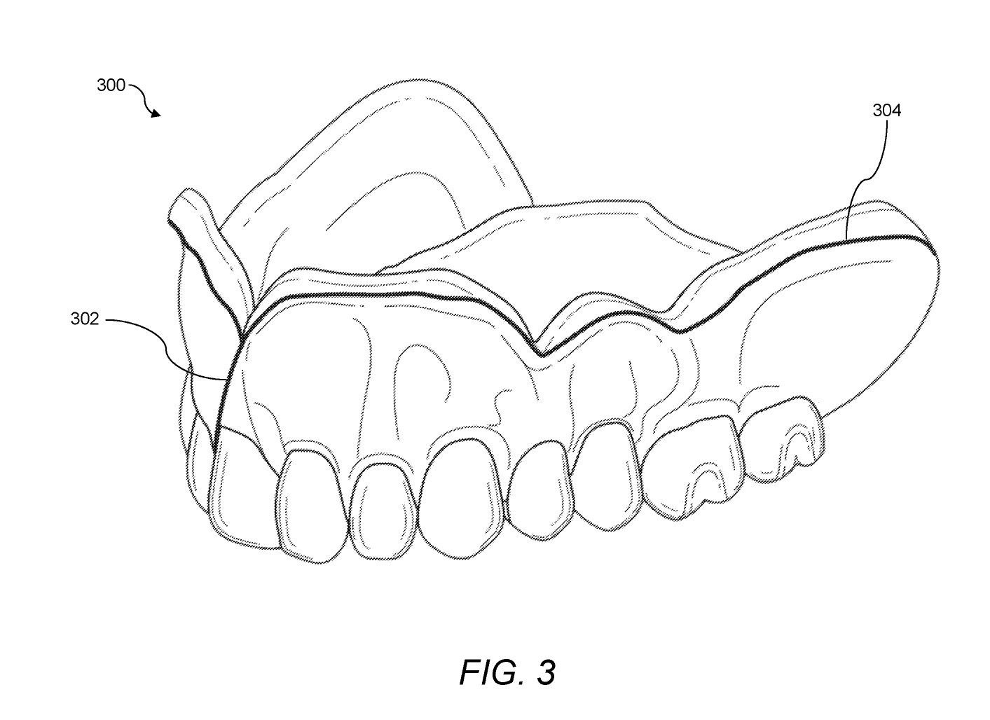

FIGS. 3-9 are shown by way of example to demonstrate a technique for creating a denture from a digital denture model, where the denture includes one or more soft tissue inserts secured to a denture base. The following figures may represent a digital manufacturing workflow for upper and/or lower dentures (or another dental appliance) using digital STL files to produce one or more denture parts for assembly into a final denture. The digital manufacturing workflow may be realized within a CAD or CAM environment that allows a designer to cut back the thickness of the denture base, e.g., the digital denture model 200 shown above in FIG. 2. The cutback volumes created can be applied to, e.g., the buccal flange, the lingual flange, and palate areas of the denture base, where the extent of the cutback volumes can include the papilla areas and can go as close to the border of the denture base as a designer desires, or as necessary or helpful for creating the final denture.

FIG. 3 shows a digital denture model with markings for the placement of cutbacks. Specifically, the digital denture model 300 includes a spline 302 and a border 304 separating different regions such as the right and left gum regions within the digital denture model 300. The markings can be placed on the digital denture model 300 by a user, e.g., manually within the modeling environment or by inputting one or more criteria or parameters. The markings can also or instead be automatically placed on the digital denture model 300. The markings may also or instead be placed using a combination of automated and manual procedures, such as where a preliminary estimate or proposal is automatically generated within a CAD environment based on the shape and structure of the digital denture model 300, followed by user modifications and refinements, or where a user can click to select several key points such as one or more points along the center line, the gum line, or other soft tissue boundaries, and so forth, and a full spline 302 or other borders or cutbacks for inserts are automatically generated.

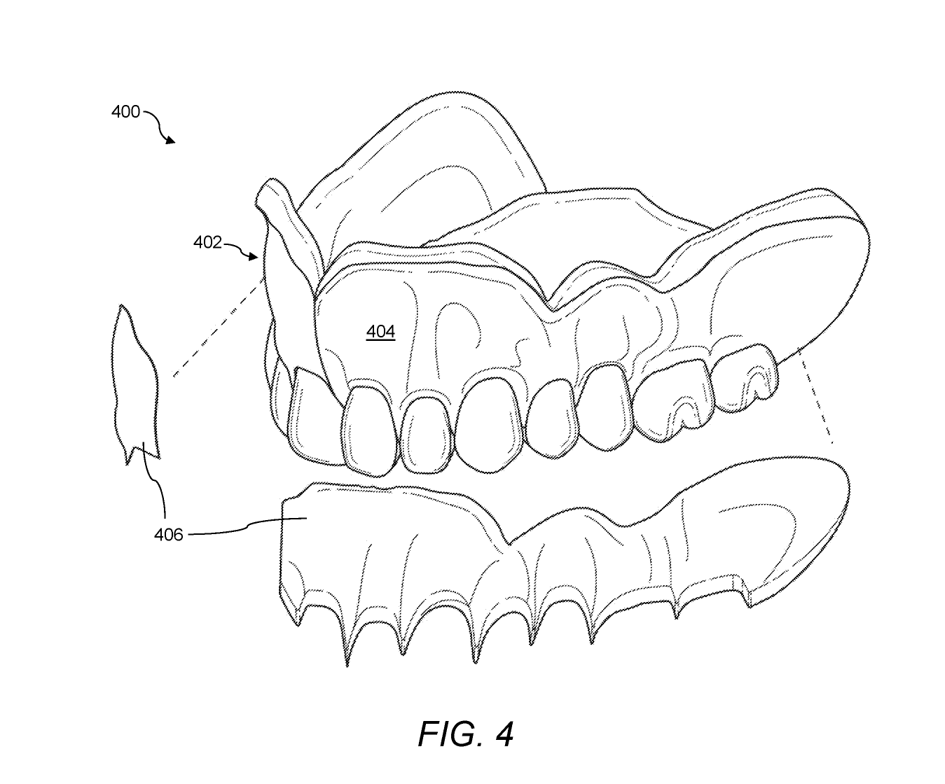

FIG. 4 shows a digital denture model with cutbacks being removed. As shown in the figure, one or more surfaces 402 of the digital denture model 400 may be cut back to form cutback volumes 404 structurally configured to receive inserts, where the inserts may be designed to mimic the cutback parts 406. To this end, the cutback parts 406 may be saved, e.g., as STL files or the like, for use in the design or fabrication of the inserts. Similarly, the digital denture model 400 that includes the one or more cutback volumes 404 may be saved, e.g., as an STL file or the like, for the creation of a denture base. The cutback volumes 404 may be formed based on the markings described in FIG. 3 above, where a predetermined or user-selected depth is used to form the cutback volumes 404 from the marked areas.

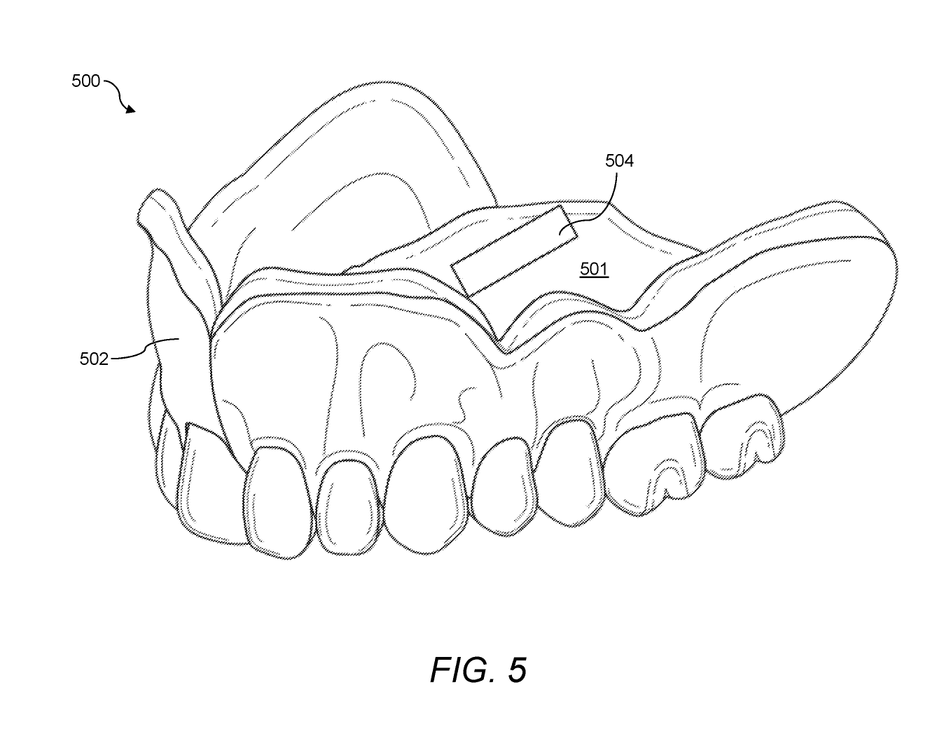

FIG. 5 shows a denture base. The denture base 500 may be formed from the digital denture model that includes cutback volumes configured to receive inserts. The denture base 500 may be milled or three-dimensionally printed, e.g., from an STL file, or cast from a corresponding mold.

In general, the denture base 500 may be integrally formed of a rigid material suitable for use as a dental prosthetic, such as a ceramic or other hard material. The denture base 500 may be shaped and sized to reconstruct existing patient dentition for a dental patient when placed for use in the dental patient's mouth. To this end, the denture base 500 may include one or more tooth surfaces corresponding to exposed tooth regions in the reconstructed patient dentition, and one or more soft tissue surfaces corresponding to soft tissue in the reconstructed patient dentition. One or more of the soft tissue surfaces may be formed by cutbacks such as at least a first cutback 502 set into a surface of the denture base 500 to receive soft tissue inserts. One or more support surfaces 501 may correspond to regions where the denture base 500 mechanically matches and engages with exposed intraoral structures in the existing patient dentition. A second cutback 504 may be set into a support surface 501 of the denture base 500, where the second cutback 504 is structurally configured to receive a support structure insert. While two cutbacks are shown, it will be understood that any number of cutbacks consistent with a reconstruction of human dentition may be used, preferably in a number and shape that simplifies human or machine assembly of the final denture. In one aspect, the cutback volumes are limited to soft tissue areas that do not engage with existing dentition. In other words, in some aspects, there is no cutback for the surfaces of the denture that directly engage with existing patient dentition.

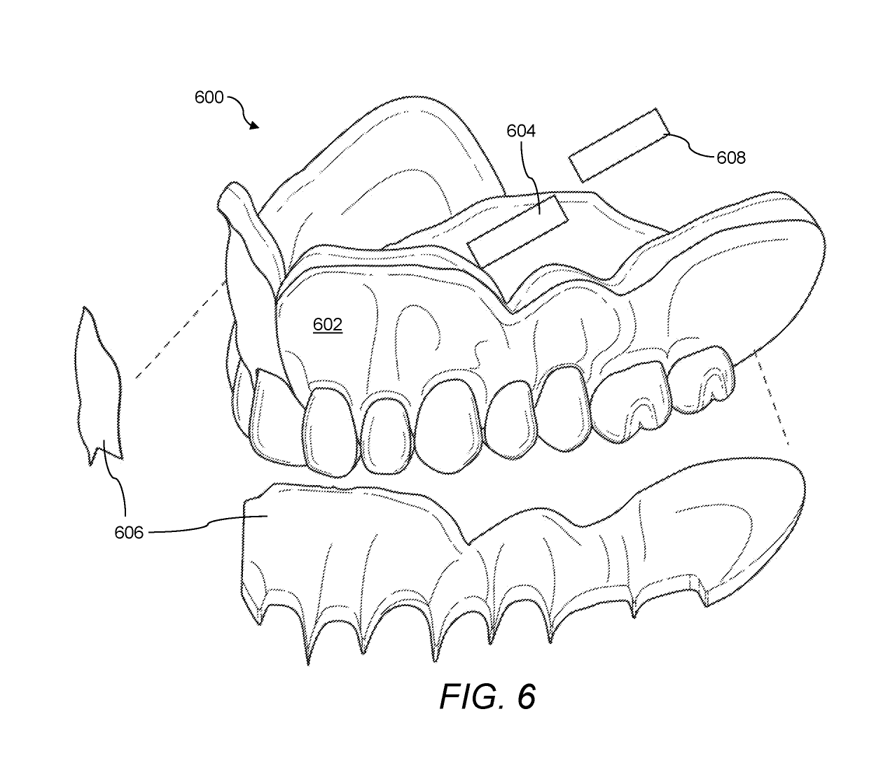

FIG. 6 shows a denture base and soft tissue inserts aligned for engagement. The denture base 600 may the same or similar to that described above in FIG. 5, e.g., including one or more cutbacks—e.g., a first cutback 602 for receiving one or more soft tissue inserts 606 and a second cutback 604 for receiving one or more support inserts 608.

The soft tissue inserts 604 may be formed of a first pliable material selected to mimic the look and feel of gum tissue. This may, for example, include a soft, low durometer, biocompatible rubber, or any other suitable material(s), which may be dyed or otherwise colored to match human gum tissue. For example, soft tissue inserts 604 may be formed of plasticized acrylic resin, silicone elastomers, or any other compliant, viscoelastic material, or the like. The soft tissue inserts 604 may be shaped and sized to fit into the first cutbacks 602 and reproduce a final shape over the soft tissue surfaces of the denture base for use in a reconstructed patient dentition. The soft tissue inserts 604 may be milled from a block or disk of pliable material (e.g., the first pliable material), three-dimensionally printed using the first pliable material, laser cut from a sheet of pliable material, cast in predetermined shapes, or otherwise fabricated for use with cutbacks in a denture base as contemplated herein.

The support tissue inserts 608 that form mating surfaces with existing dentition may be formed of a second pliable material. The support tissue inserts 608 may be shaped and sized to fit into the second cutbacks 604 and provide a mating surface suitable for supporting the denture base 600 when placed for use on existing patient dentition. The support tissue inserts 608 may, in general, be formed of any of the materials, and using any of the techniques, described for use with the soft tissue inserts 604. In one aspect, the aesthetic finish may be changed, e.g., to improve grip or adhesion, and the coloring requirements may be relaxed on surfaces that are not visible when the denture is in use.

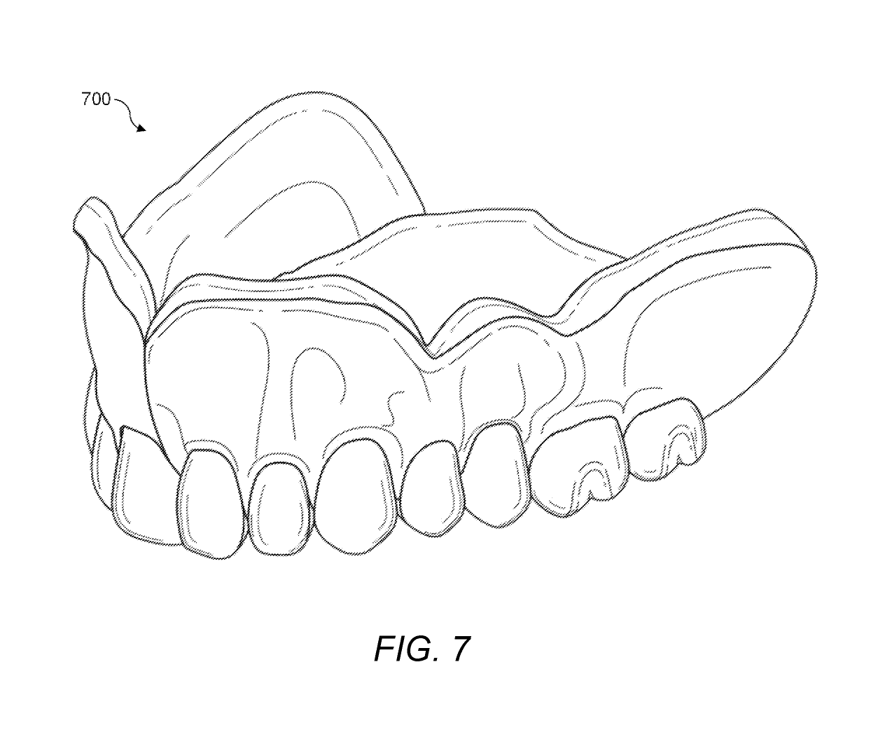

FIG. 7 shows a denture. The denture 700 shown may include a fully assembled denture 700, e.g., including inserts secured to soft tissue and/or support surfaces as described herein.

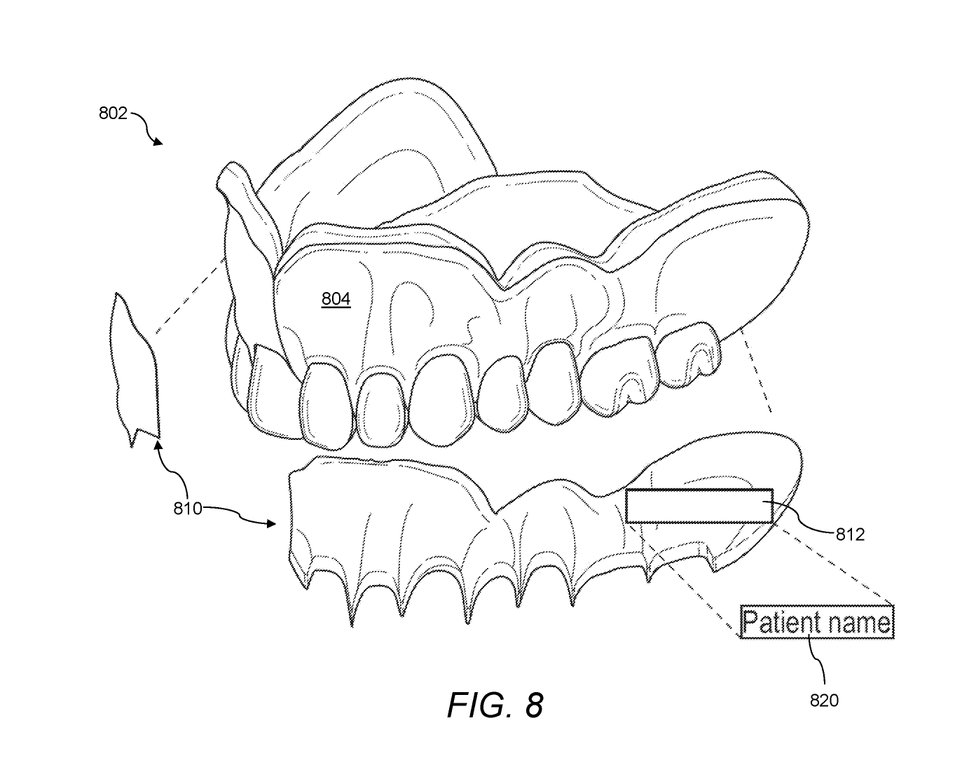

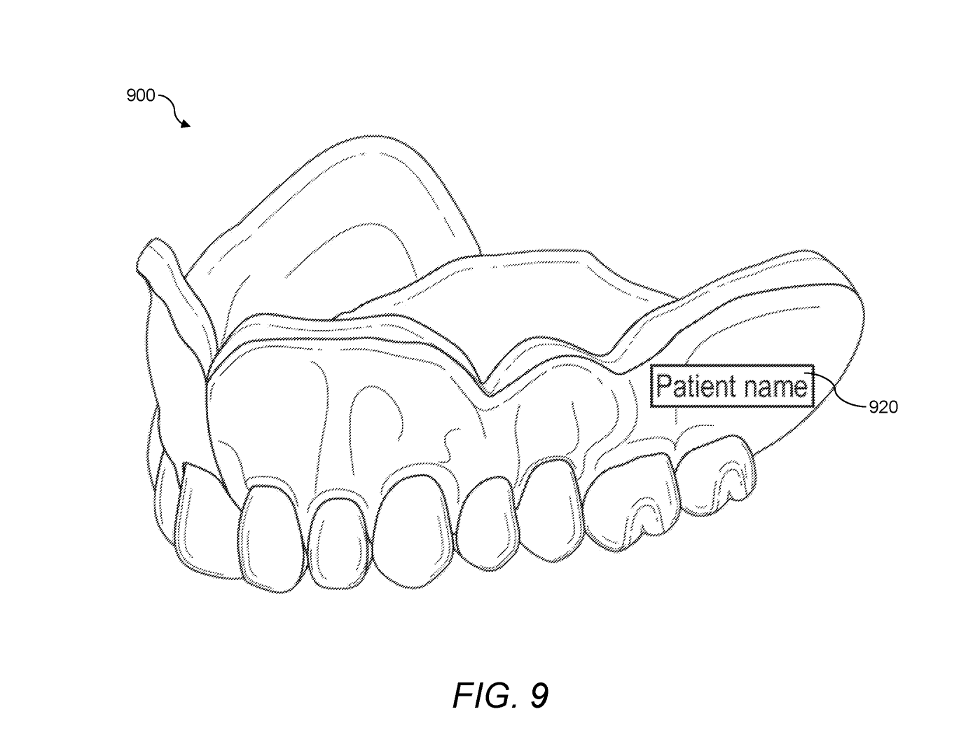

FIGS. 8 and 9 are shown, by way of example, to demonstrate a technique for placing an identifier on a denture designed from a digital denture model, where the denture includes one or more soft tissue inserts secured to a denture base.

FIG. 8 shows digital denture models. Specifically, the figure shows a first digital denture model 802 of a denture base having one or more cutbacks 804 configured to receive soft tissue inserts, and second digital denture models 810 of the soft tissue inserts.

As shown in the figure, one or more of the first digital denture model 802 and the second digital denture models 810 may be configured to include an identifier 820 therein or thereon. For example, at least one of the second digital denture models 810 of the soft tissue inserts may include a cutout 812 for placement or display of the identifier 820. The identifier 820 may include patient information such as a patient's name. The identifier 820 may also or instead include other information such as a denture type, a denture characteristic (e.g., material, color, and so on), a dental practitioner or practice name, a manufacturer name, a serial number, and so on. In some aspects, the identifier 820 is integrally formed on one or more of the denture base and the soft tissue inserts. For example, the identifier 820 may be formed on a cutback 804 of the denture base (e.g., fabricated as part of the denture base by milling or three-dimensional printing) and the soft tissue inserts may include a cutout 812 or a substantially transparent portion for viewing the identifier 820. Thus, techniques may enable a designer to place a rectangular (or other shape) void in one or more of the digital denture models 810 for placement of the identifier 820 therein or thereon. In other aspects, the identifier 820 is added to one or more of the denture base and the soft tissue inserts. The identifier 820 can be created or saved as a separate file, and can be configured for separate fabrication, e.g., via three-dimensional printing or otherwise.

FIG. 9 shows a denture. The denture 900 in the figure may include a fully assembled denture 900, e.g., including inserts secured to soft tissue and/or support surfaces. The denture 900 may include an identifier 920 such as those described above.

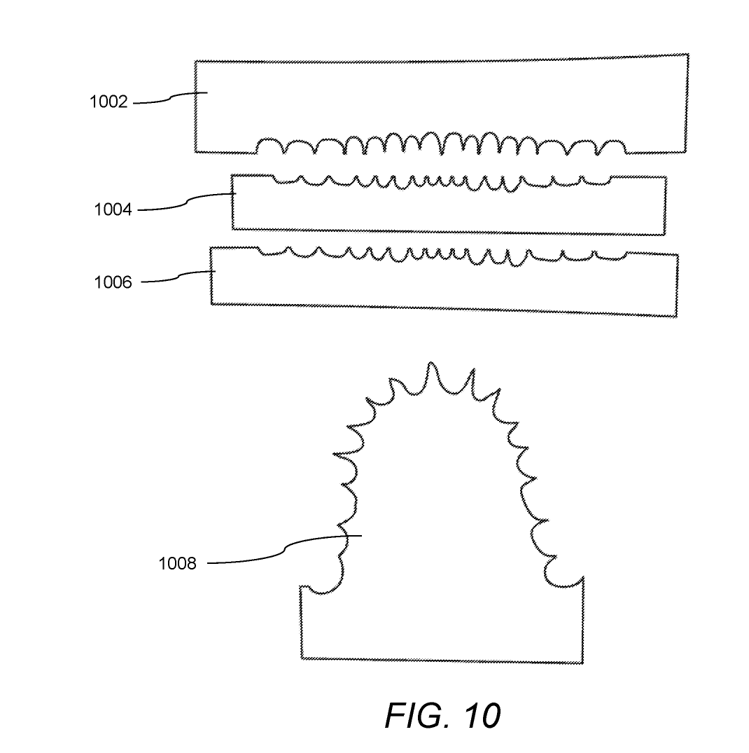

FIG. 10 shows soft tissue inserts. The soft tissue inserts shown in the figure may include pre-cut composite shapes for inserts structurally configured to be applied to a denture base. The first soft tissue insert 1002 may be structurally configured to mimic a maxillary labial flange of a patient. The second soft tissue insert 1004 may be structurally configured to mimic a mandibular lingual flange of a patient. The third soft tissue insert 1006 may be structurally configured to mimic a mandibular buccal flange of a patient. The fourth soft tissue insert 1008 may be structurally configured to mimic a maxillary palate of a patient. Other soft tissue inserts are also or instead possible. Also, it will be understood that the soft tissue inserts shown may be divided into separate portions for separate placement onto a denture base.

As shown in FIG. 10, the soft tissue inserts may include prefabricated, tissue-like strips, which may include pink composite materials cut into strips or shapes that closely resemble the shapes of cutback volumes of a digital denture model. In some aspects, the soft tissue inserts are precut in a scallop shape to mimic the papilla areas of soft tissue that surrounds the gingival aspect of teeth. The soft tissue inserts may also include the small spikes that are found in natural dentition, e.g., between teeth, and that extend towards (but not to) the incisal edge of teeth. In addition, there may be several different dimensions for such soft tissue inserts, which can be made from pink veneering sheets or the like. For example, there may be one or more sizes for the labial, lingual, and palate components, and/or for different general jaw or tooth sizes. The soft tissue inserts can be hand-applied to a milled or three-dimensionally printed denture base, or applied via mechanical and/or automated means. In certain implementations, a bonding agent is used to bond the soft tissue inserts to the denture base.

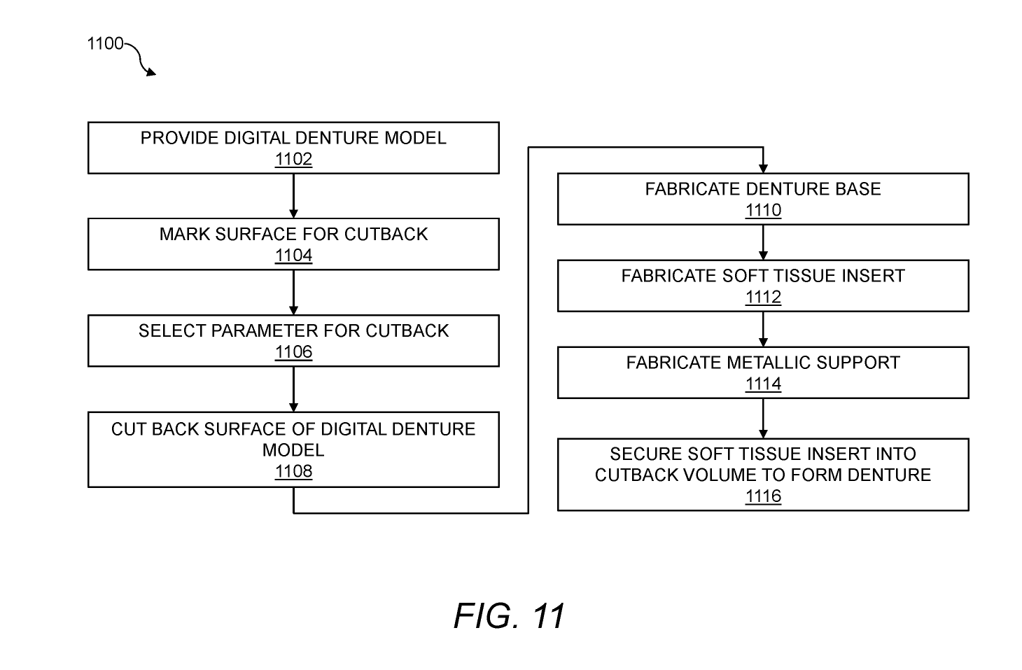

FIG. 11 is a flow chart of a method for making a denture. The denture may be the same or similar to any dentures described herein. For example, the denture may include soft tissue inserts secured to a denture base, where the soft tissue inserts may be structurally configured to mimic the soft tissue of a dental patient and/or structurally configured to form supports for a junction between the denture and the existing dentition of a dental patient.

As shown in step 1102, the method 1100 may include providing a digital denture model, e.g., in a digital modeling environment such as a CAD or CAM modeling environment. The digital denture model may be shaped to provide a reconstructed patient dentition for an existing patient dentition when placed for use on the existing patient dentition. As such, the digital denture model may include an integral digital representation of a denture structure that contains one or more tooth surfaces corresponding to exposed tooth regions in the reconstructed patient dentition, one or more soft tissue surfaces corresponding to soft tissue in the reconstructed patient dentition, and one or more support surfaces corresponding to regions where the denture structure mechanically matches and engages with one or more exposed intraoral structures in the existing patient dentition. As discussed herein, the digital denture model may include one or more of an upper jaw portion and a lower jaw portion.

Providing the digital denture model may include selecting the digital denture model from a database of prefabricated models. The prefabricated models may, for example, include collections of standard tooth models with a range of sizes so that a particular size may be selected for a patient and arranged in a base within the modeling environment. The base that receives such tooth models may also be standardized, with an interface to patient dentition derived from a physical cast, a digital scan, or any other suitable source. The base may also or instead be a fully custom base derived from a three-dimensional model or discrete measurements of a patient's existing jaw and dentition. In another aspect, the tooth models may be derived from prior dentition for a patient where suitable digital data or physical models are available. Thus, in one aspect, a digital denture model may then be derived from standard models and manipulated for a particular patient within the digital modeling environment, e.g., such that the digital denture model is at least partly customized. Also, or instead, providing the digital denture model may include creating the digital denture model based on measurements or scanning of a patient, e.g., providing a completely customized digital denture model.

Similarly, the tooth surfaces of the digital denture model, or generally the teeth of the digital denture model, may be based on a prefabricated tooth model. The prefabricated tooth model may come in predetermined sizes, e.g., small, medium, and large. In other aspects, the tooth surfaces of the digital denture model, or generally the teeth of the digital denture model, may be based on a custom tooth model. For example, measurements or a scan may be taken of a patient's existing teeth or dental records, and a custom tooth model may be created therefrom.

As shown in step 1104, the method 1100 may include marking surfaces of the digital denture model in the digital modeling environment for placement of cutback volumes on the digital denture model. The markings may be placed by a user within the digital modeling environment, or automatically created.

As shown in step 1106, the method 1100 may include selecting one or more parameters for creation of cutback volumes on the digital denture model. The parameters may include without limitation one or more of a size or a depth of a cutback volume, a type or shape of a cutback, and so on. Thus, as described herein, cutting back the surface of the digital denture model may include selecting a depth of one or more the cutback volumes. The depth of one or more of the cutback volumes may be included in the range of about 0.5 mm to about 5 mm, and may vary according to, e.g., the shape and size of existing bone structure, the position of the soft tissue being replaced, and so forth.

In general, this may include automatic selection of parameters based on, e.g., denture geometry, location of intended inserts, material used for inserts, and so forth. Thus, for example, inserts selected to abut the palate may provide stability and comfort to the denture, while inserts that establish a visible gum line may provide aesthetic qualities (e.g., in addition to comfort). These inserts perform different roles and may thus use different materials that imply different cutbacks for optimal performance of the denture. Other parameters such as cutback shape, boundaries, segmentation, and so forth may also or instead be provided, either by a human user for use in creating suitable cutbacks, or by a computer based on, e.g., denture geometry, user-selected materials for inserts, and so forth.

As shown in step 1108, the method 1100 may include cutting back a surface of the digital denture model beneath one or more soft tissue surfaces and one or more support surfaces to provide a second digital denture model that includes cutback volumes to receive inserts. Thus, the cutback volumes may be located on one or both of soft tissue surfaces and support surfaces. As such, the soft tissue inserts may include a first soft tissue insert for support surfaces and a second soft tissue insert for soft tissue surfaces.

Cutting back a surface of the digital denture model may also or instead include cutting back a second surface of the digital denture model for placement of an identifier. In this manner, one or more of the cutback volumes may include an identifier, or a space for an identifier.

As shown in step 1110, the method 1100 may include physically fabricating a denture base from the second digital denture model (e.g., the digital denture model including the cutback volumes). Physically fabricating the denture base may include one or more of milling with a milling machine and printing with a three-dimensional printer, for example. A variety of materials suitable for milling into a dental device are known in the art, and may be used with a milling machine or otherwise as contemplated herein. Similarly, a variety of three-dimensional printing techniques and materials may be used to provide an object with a suitable shape, aesthetic properties, and mechanical/structural properties for use as the denture base, any of which may be adapted for use in a three-dimensional printing process (or other manufacturing process) as contemplated herein. In another aspect, a cast for the denture base may be fabricated and invested using any suitable materials.

As shown in step 1112, the method 1100 may include fabricating the soft tissue inserts. Fabrication of the soft tissue inserts may be based upon a digital model of a difference between the digital denture model (without the cutbacks) and the second digital denture model (with the cutbacks). The soft tissue inserts may also or instead be based on a prefabricated soft tissue model, a semi-custom soft tissue model, or a custom soft tissue model. For example, the soft tissue inserts may be selected from a database of available inserts that are sized and shaped according to patient characteristics. In other aspects, the soft tissue inserts may be designed from measurements or a scan taken of a patient's intraoral anatomy.

As discussed above, the soft tissue inserts may include a first soft tissue insert for the support surfaces and a second soft tissue insert for the soft tissue surfaces. Thus, in some implementations, the first soft tissue insert may be a different material than the second soft tissue insert. To this end, the first soft tissue insert may be made from a material configured to provide support, while the second soft tissue insert may be made from a material configured to mimic the aesthetics and feel of soft tissue. As such, one or more soft tissue inserts may include a support insert structurally configured to be disposed between the denture base and one or more exposed intraoral structures of a patient. Such exposed intraoral structures may include one or more of a roof area, a palate area, a papilla area, and a base area.

The soft tissue inserts may be fabricated using a milling machine, a three-dimensional printer, a laser cutter, a molding process, or some combination of these, or any other suitable techniques for forming the corresponding materials into a standard or customized shape for use as a soft tissue insert. The soft tissue inserts may include one or more pieces, e.g., there may be two to five soft tissue inserts per denture base.

In some implementations, and as discussed above, one or more soft tissue inserts may include an identifier, or a space for the placement or viewing of an identifier.

As shown in step 1114, the method 1100 may include fabricating a metallic support structure within the denture base (or a support structure made from another substantially rigid material besides metal). This may, for example, include casting a denture base around a separately fabricated metallic support structure or otherwise fabricating a final object with an interior metallic structure to mechanically support a denture base. In some aspects, the metallic support structure is contained within a ceramic disc or the like that is milled to form the denture base or a portion of the denture base that contains the metallic support structure. In other aspects, the denture base is three-dimensionally printed or otherwise fabricated about the metallic support structure. The metallic support structure may also or instead be inserted within a denture base, which may include one or more volumes shaped and sized to receive such a metallic support structure.

As shown in step 1116, the method 1100 may include securing one or more soft tissue inserts into the cutback volumes, e.g., to restore an external surface shape of the digital denture model. Securing the soft tissue inserts into the cutback volumes may include bonding the soft tissue inserts to the denture base using a bonding agent or the like.

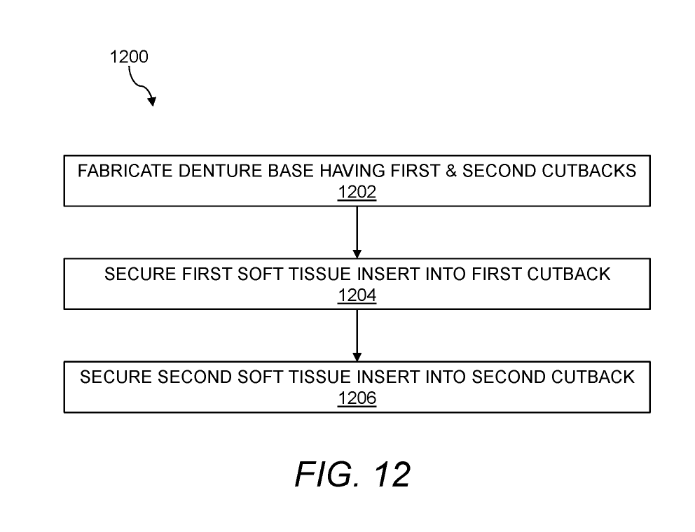

FIG. 12 is a flow chart of a method for making a denture.

As shown in step 1202, the method 1200 may include fabricating a denture base integrally formed of a rigid material suitable for use as a dental prosthetic. The denture base may be shaped and sized to provide a reconstructed patient dentition for an existing patient dentition when placed for use on the existing patient dentition. The denture base may include one or more tooth surfaces corresponding to exposed tooth regions in the reconstructed patient dentition, one or more soft tissue surfaces corresponding to soft tissue in the reconstructed patient dentition and defining one or more first cutbacks set into a surface of the denture base to receive soft tissue inserts, and one or more support surfaces corresponding to regions where the denture base mechanically matches and engages with one or more exposed intraoral structures in the existing patient dentition and defining one or more second cutbacks set into the surface of the denture base to receive support structure inserts.

As shown in step 1204, the method 1200 may include securing one or more first soft tissue inserts into the one or more first cutbacks to reproduce a final shape for the reconstructed patient dentition.

As shown in step 1206, the method 1200 may include securing one or more second soft tissue inserts into the one or more second cutbacks to provide a mating surface suitable for supporting the denture base when placed for use on the existing patient dentition.

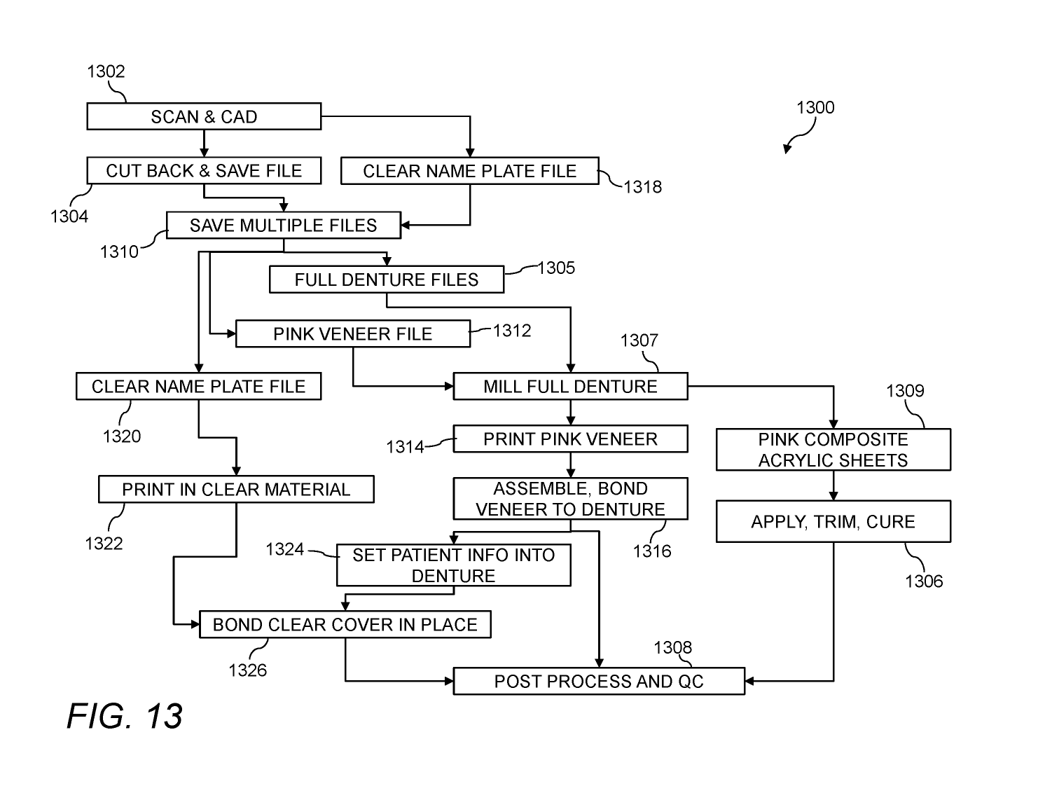

FIG. 13 is a flow chart of workflows for making a denture.

The overall workflow 1300 may include a first workflow for making a denture that includes scanning or measuring a patient's existing dentition and providing a digital denture model corresponding to the patient's existing dentition in a digital modeling environment as shown in block 1302. The first workflow may also include cutting back a portion of the digital denture model in one or more of soft tissue surfaces and support surfaces, and saving the file as shown in block 1304. In some aspects, the cutting back is limited to the non-tissue side of the digital denture model, and more specifically the cutting back may be limited to the flange and palate areas. The digital denture model including the cutbacks (e.g., the second digital denture model discussed above) may be saved as a single file, e.g., a STL file or similar, where full denture files are represented by block 1305. A denture base that corresponds to this file can be milled or three-dimensionally printed, e.g., using a tooth-colored material, as shown in block 1307.

The first workflow may further include adding soft tissue inserts to the fabricated digital denture model. This may include a manual or automated process of adding the soft tissue inserts, which may be made from a pink composite or acrylic-type material, to the cutbacks of the fabricated denture base. The soft tissue inserts may also or instead include prefabricated strips that conform to the shape of the cutbacks. In this manner, the soft tissue inserts can include a scallop shape to mimic and fill the papilla areas or the flange area. The soft tissue inserts may be substantially elastic such that they can be stretched or otherwise manipulated as needed. Thus the workflow may include acquiring the soft tissue inserts as shown in block 1309. Once secured on the denture base, the soft tissue may be trimmed and cured as shown in block 1306. This may be followed by one or more post-processing steps such as checking the occlusion and polishing as shown in block 1308.

A second workflow for making a denture may include scanning or measuring as discussed herein or as known in the art, providing one or more digital denture models in a digital modeling environment, and saving the files. However, additional files saved in the second workflow (as shown in block 1310) may include shapes for the areas that are cutback (as shown in block 1312), which are then used for fabricating the soft tissue inserts (as shown in block 1314). These additional files may be three-dimensionally printed or milled, e.g., using pink, tissue-like material, for bonding or otherwise adhering to a denture base (as shown in block 1316).

One or more of the workflows may include providing an identifier. For example, the labeling of a patient's name may include a CAD step of placing a void in one or more of the digital denture models (as shown in block 1318). The identifier (or the void for placing the identifier) may be saved as a separate file, e.g., a STL file, as shown in block 1320, where the identifier or void can be milled or three-dimensionally printed (as shown in block 1322), e.g., using a clear material. In one workflow, the soft tissue inserts are bonded to the denture base and the identifier is placed into the void (as shown in block 1324), which is located within a soft tissue insert. The identifier may then be covered with the clear, fabricated portion, which can be bonded or placed with an acrylic-type material as shown in block 1326.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example, performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A method, comprising:
providing a digital denture model in a digital modeling environment, the digital denture model shaped to provide a reconstructed patient dentition for an existing patient dentition when placed for use on the existing patient dentition, the digital denture model including an integral digital representation of a denture structure that contains one or more tooth surfaces corresponding to exposed tooth regions in the reconstructed patient dentition, one or more soft tissue surfaces corresponding to soft tissue in the reconstructed patient dentition, and one or more support surfaces corresponding to regions where the denture structure mechanically matches and engages with one or more exposed intraoral structures in the existing patient dentition;
cutting back a surface of the digital denture model beneath the one or more soft tissue surfaces and the one or more support surfaces to provide a second digital denture model that includes cutback volumes to receive inserts;
physically fabricating a denture base from the second digital denture model; and
securing one or more soft tissue inserts into the cutback volumes to restore an external surface shape of the digital denture model.

2. The method of claim 1, wherein the one or more soft tissue inserts includes a first soft tissue insert for the support surfaces and a second soft tissue insert for the soft tissue surfaces, and wherein the first soft tissue insert is a different material than the second soft tissue insert.

3. The method of claim 1, further comprising fabricating the one or more soft tissue inserts based upon a digital model of a difference between the digital denture model and the second digital denture model.

4. The method of claim 3, wherein the one or more soft tissue inserts are fabricated using one or more of a milling machine and a three-dimensional printer.

5. The method of claim 1, wherein physically fabricating the denture base includes one or more of milling with a milling machine and printing with a three-dimensional printer.

6. The method of claim 1, further comprising fabricating a metallic support structure within the denture base.

7. The method of claim 1, wherein the digital denture model includes one or more of an upper jaw portion and a lower jaw portion.

8. The method of claim 1, wherein cutting back the surface of the digital denture model includes selecting a depth of one or more of the cutback volumes.

9. The method of claim 1, wherein a depth of one or more of the cutback volumes is between 0.5 mm and 5 mm.

10. The method of claim 1, wherein cutting back the surface of the digital denture model includes selecting one or more parameters for creation of the cutback volumes.

11. The method of claim 1, further comprising marking surfaces for placement of the cutback volumes on the digital denture model in the digital modeling environment.

12. The method of claim 1, wherein the one or more tooth surfaces of the digital denture model are based on a prefabricated tooth model.

13. The method of claim 1, wherein the one or more tooth surfaces of the digital denture model are based on a custom tooth model.

14. The method of claim 1, wherein the one or more soft tissue inserts are based on a prefabricated soft tissue model.

15. The method of claim 1, wherein the one or more soft tissue inserts are based on a custom soft tissue model.

16. The method of claim 1, wherein providing the digital denture model includes selecting the digital denture model from a database of prefabricated models.

17. The method of claim 1, wherein providing the digital denture model includes creating the digital denture model based on measurements of the existing patient.

18. The method of claim 1, wherein the one or more soft tissue inserts includes a support insert structurally configured to be disposed between the denture base and one or more exposed intraoral structures of the existing patient.

19. The method of claim 18, wherein the one or more exposed intraoral structures includes one or more of a roof area, a palate area, a papilla area, and a base area.

20. The method of claim 1, wherein one or more of the cutback volumes and the one or more soft tissue inserts include an identifier.

21. The method of claim 20, wherein the identifier includes patient information.

22. The method of claim 1, further comprising cutting back a second surface of the digital denture model for placement of an identifier.

23. The method of claim 1, wherein securing the one or more soft tissue inserts into the cutback volumes includes bonding the one or more soft tissue inserts to the denture base using a bonding agent.

24. A method, comprising:
fabricating a denture base integrally formed of a rigid material suitable for use as a dental prosthetic, the denture base shaped and sized to provide a reconstructed patient dentition for an existing patient dentition when placed for use on the existing patient dentition, the denture base including one or more tooth surfaces corresponding to exposed tooth regions in the reconstructed patient dentition, one or more soft tissue surfaces corresponding to soft tissue in the reconstructed patient dentition and defining a one or more first cutbacks set into a surface of the denture base to receive soft tissue inserts, and one or more support surfaces corresponding to regions where the denture base mechanically matches and engages with one or more exposed intraoral structures in the existing patient dentition and defining one or more second cutbacks set into the surface of the denture base to receive support structure inserts;
securing one or more first soft tissue inserts into the one or more first cutbacks to reproduce a final shape for the reconstructed patient dentition; and
securing one or more second soft tissue inserts into the one or more second cutbacks to provide a mating surface suitable for supporting the denture base when placed for use on the existing patient dentition.

25. A denture comprising:
a denture base integrally formed of a rigid material suitable for use as a dental prosthetic, the denture base shaped and sized to provide a reconstructed patient dentition for an existing patient dentition when placed for use on the existing patient dentition, the denture base including one or more tooth surfaces corresponding to exposed tooth regions in the reconstructed patient dentition, one or more soft tissue surfaces corresponding to soft tissue in the reconstructed patient dentition and defining one or more first cutbacks set into a surface of the denture base to receive soft tissue inserts, and one or more support surfaces corresponding to regions where the denture base mechanically matches and engages with one or more exposed intraoral structures in the existing patient dentition and defining one or more second cutbacks set into the support surface of the denture base to receive support structure inserts;
one or more soft tissue inserts formed of a first pliable material selected to mimic a look and feel of gum tissue, the one or more soft tissue inserts shaped and sized to fit into the one or more first cutbacks and reproduce a final shape over the one or more soft tissue surfaces for use in the reconstructed patient dentition; and
one or more support tissue inserts formed of a second pliable material, the one or more support tissue inserts shaped and sized to fit into the one or more second cutbacks and provide a mating surface suitable for supporting the denture base when placed for use on the existing patient dentition.
